(19) United States
(12) Patent Application Publication
(10) Pub. No.: US 2021/0408708 A1
(43) Pub. Date: Dec. 30, 2021

(54) Terminal

(71) Applicant: I-PEX Inc., Kyoto (JP)

(72) Inventor: Takuya Takeda, Shizuoka (JP)

(73) Assignee: I-PEX Inc., Kyoto (JP)

(21) Appl. No.: 17/342,010

(22) Filed: Jun. 8, 2021

(30) Foreign Application Priority Data
Jun. 26, 2020 (JP) 2020-110141
Apr. 22, 2021 (JP) 2021-072338

(51) Int. Cl. H01R 13/05; H01R 13/436; H01R 13/11

(52) U.S. Cl. CPC H01R 13/055; H01R 13/113; H01R 13/4367

(57) ABSTRACT

A terminal is inserted between a first contact and a second contact, formed in the interior of a mating terminal. The terminal includes a plurality of first projections and a second projection. The first projections are disposed on the first surface, and protrude in an orthogonal direction orthogonal to an insertion direction while linearly extending in the insertion direction in which the terminal is inserted into the mating terminal. The second projection is disposed on the second surface, and protrudes in the orthogonal direction. The first projections and the second projection are disposed at positions at which the first projections and the second projection come into contact with the first contact and the second contact, respectively, in a state in which the terminal has been connected to the mating terminal.

### CROSS-REFERENCE TO RELATED APPLICATION

This application claims the benefit of Japanese Patent Application No. 2020-110141, filed on Jun. 26, 2020, and Japanese Patent Application No. 2021-72338, filed on Apr. 22, 2021, of which the entirety of the disclosures is incorporated by reference herein.

### FIELD

This application relates to a terminal.

### BACKGROUND

Japanese Utility Model Application Publication No. H5-17944 discloses a pin contact (terminal) inserted between two contacts formed in the interior of a socket contact. The terminal has a generally prismatic shape including: an upper surface that comes into contact with one of the two contacts in the interior of the socket contact; and a lower surface that comes into contact with the other. Projection-shaped portions that linearly extend in an insertion direction in which the terminal is inserted into the socket contact are formed on both of the upper and lower surfaces of the terminal, respectively.

In accordance with the terminal described in Japanese Utility Model Application Publication No. H5-17944, the projection-shaped portions on the upper and lower surfaces of the terminal come into contact with the two contacts in the interior of the socket contact, respectively, in a state in which the terminal is inserted into the socket contact. Accordingly, the terminal described in Japanese Utility Model Application Publication No. H5-17944 comes into line contact to each of the upper and lower surfaces of the mating terminal. As a result, the terminal described in Japanese Utility Model Application Publication No. H5-17944 has had a problem that the terminal takes an instable posture with respect to the mating terminal, for example, inclines in a direction intersecting with respect to the insertion direction of the terminal into the mating terminal, although the insertion force of the terminal into the mating terminal can be decreased.

The present disclosure was made under the above-described circumstances, with an objective to provide a terminal of which the posture with respect to a mating terminal can be stabilized in a state in which the terminal comes into contact with the mating terminal while decreasing the insertion force of the terminal into the mating terminal.

### SUMMARY

In order to achieve the above-described objective, a terminal according to the present disclosure is a terminal inserted between a first contact and a second contact, formed in an interior of a mating terminal,

the terminal being formed in a shape including a first surface that comes into contact with the first contact and a second surface that comes into contact with the second contact,

the terminal including:

a plurality of first projections that is disposed on the first surface, and protrude in an orthogonal direction orthogonal to an insertion direction while linearly extending in the insertion direction in which the terminal is inserted into the mating terminal; and

a second projection that is disposed on the second surface, and protrudes in the orthogonal direction,

wherein the first projections are disposed at positions at which the first projections come into contact with the first contact, and the second projection is disposed at a position at which the second projection comes into contact with the second contact, in a state in which the terminal has been connected to the mating terminal.

In the terminal,

the second projection of which a number is one may be formed on the second surface, and may linearly extend in the insertion direction.

The terminal may include:

a plurality of third projections that is disposed on the second surface, is disposed at positions closer to a leading end of the terminal in the insertion direction than the position at which the second projection is disposed, and protrudes in the orthogonal direction while linearly extending in the insertion direction.

In the terminal,

the third projections may be disposed to be adjacent to the second projection in the insertion direction.

In the terminal,

the third projections may be formed so that heights of the third projections that protrude in the orthogonal direction are equivalent to a height of the second projection.

In the terminal,

the third projections may be formed so that the heights of the third projections that protrude in the orthogonal direction are higher than the height of the second projection.

The posture of the terminal according to the present disclosure with respect to a mating terminal can be stabilized in a state in which the terminal comes into contact with the mating terminal while decreasing the insertion force of the terminal into the mating terminal.

### BRIEF DESCRIPTION OF THE DRAWINGS

A more complete understanding of this application can be obtained when the following detailed description is considered in conjunction with the following drawings, in which:

FIG. 1 is a perspective view of a terminal and a mating terminal according to Embodiment 1 of the present disclosure;

FIG. 2A is a plan view of the terminal and the mating terminal according to Embodiment 1 of the present disclosure;

FIG. 2B is a cross-sectional view taken along the line A-A of FIG. 2A;

FIG. 3 is a cross-sectional view of a connector unit housing the terminal and the mating terminal according to Embodiment 1 of the present disclosure;

FIG. 4 is a cross-sectional view taken along the line C-C of FIG. 3;

FIG. 5 is an exploded cross-sectional view of the terminal and a connector housing according to Embodiment 1 of the present disclosure;

FIG. 6 is a cross-sectional view taken along the line D-D of FIG. 5;

FIG. 7 is a perspective view (1) of the terminal according to Embodiment 1 of the present disclosure;

FIG. 8 is a perspective view (1) of the terminal according to Embodiment 1 of the present disclosure, viewed from the bottom surface side of the terminal;

FIG. 9 is a perspective view of the terminal and the mating terminal according to Embodiment 1 of the present disclosure, viewed from the bottom surface side of the terminal and the mating terminal;

FIG. 10A is a cross-sectional view taken along the line E-E of FIG. 9;

FIG. 10B is a perspective view of the elastic plate of the mating terminal according to Embodiment 1 of the present disclosure;

FIG. 11 is a cross-sectional view taken along the line B-B of FIG. 2A;

FIG. 12A is a cross-sectional view (1) for explaining a method of connecting the terminal according to Embodiment 1 of the present disclosure to the mating terminal;

FIG. 12B is a cross-sectional view taken along the line F-F of FIG. 12A;

FIG. 12C is a cross-sectional view (2) for explaining the method of connecting the terminal according to Embodiment 1 of the present disclosure to the mating terminal;

FIG. 12D is a cross-sectional view taken along the line G-G of FIG. 12C;

FIG. 12E is a cross-sectional view (3) for explaining the method of connecting the terminal according to Embodiment 1 of the present disclosure to the mating terminal;

FIG. 12F is a cross-sectional view taken along the line H-H of FIG. 12E;

FIG. 13A is a cross-sectional view for explaining the effect of the terminal according to Embodiment 1 of the present disclosure;

FIG. 13B is a cross-sectional view of a terminal according to Comparative Example 1;

FIG. 14A is a cross-sectional view of a mating terminal according to Comparative Example 2;

FIG. 14B is a perspective view of an elastic plate according to Comparative Example 2;

FIG. 15 is a perspective view of a terminal according to Embodiment 2 of the present disclosure, viewed from the bottom surface side of the terminal;

FIG. 16A is a perspective view (2) of the terminal according to Embodiment 1 of the present disclosure;

FIG. 16B is a perspective view of a terminal according to Alternative Example 1;

FIG. 17A is a perspective view (2) of the terminal according to Embodiment 1 of the present disclosure, viewed from the bottom surface side of the terminal; and

FIG. 17B is a perspective view of a terminal according to Alternative Example 2, viewed from the bottom surface side of the terminal.

### DETAILED DESCRIPTION

### Embodiment 1

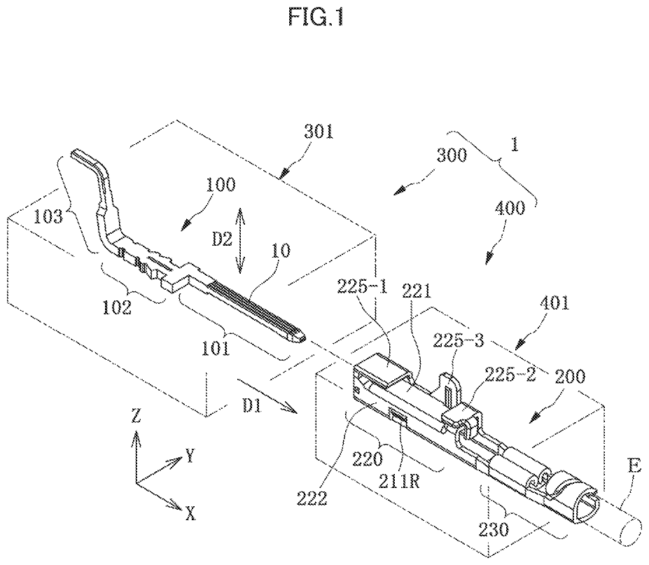

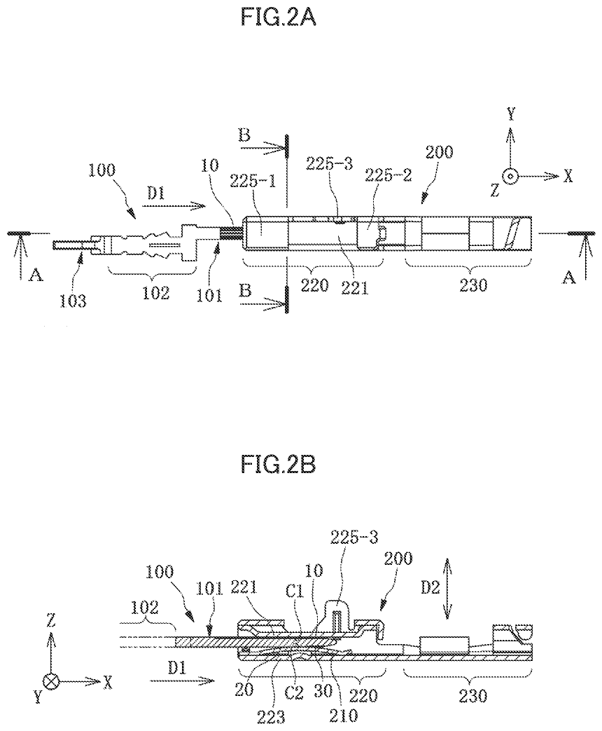

A terminal 100 according to Embodiment 1 of the present disclosure will be described with reference to the drawings. For facilitating understanding, the XYZ coordinates orthogonal to each other are set, and reference to the XYZ coordinates is made as appropriate. The X-axis direction of the XYZ coordinates is a direction identical to the insertion direction D1 of the terminal 100 into a mating terminal 200, as illustrated in FIGS. 1, 2A, and 2B. The Z-axis direction is a direction identical to an orthogonal direction D2 to which the insertion direction D1 is orthogonal, and in which the first projection 10 of the terminal 100, described later, and the like protrude. The Y-axis direction is a direction orthogonal to both the X-axis direction and the Z-axis direction.

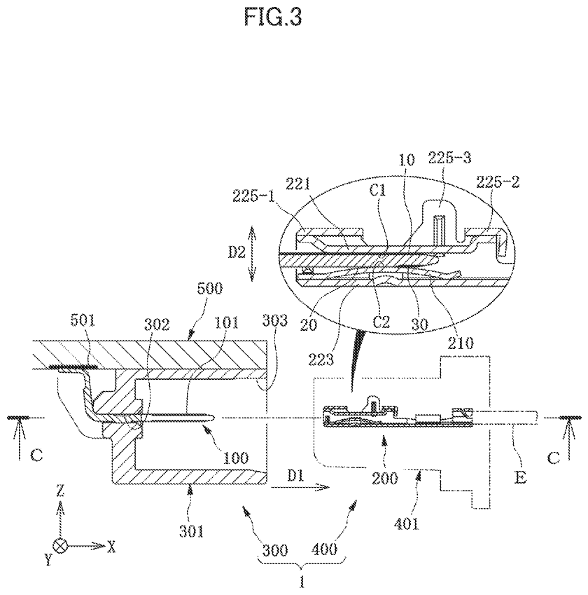

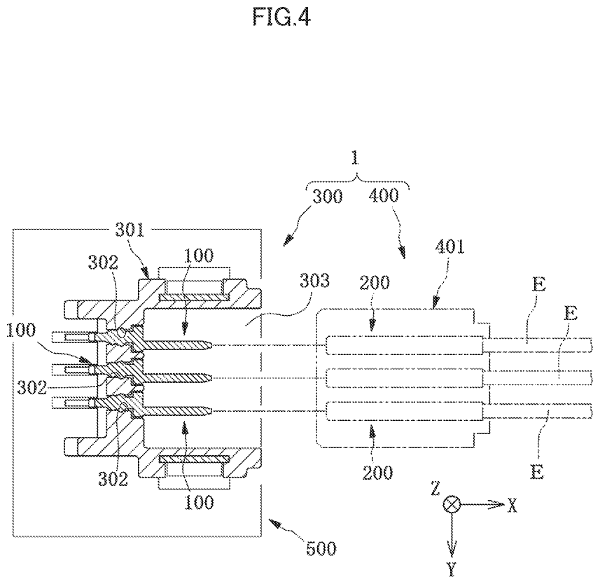

As illustrated in FIGS. 3 and 4, the terminal 100 is housed in the connector housing 301 of a connector 300 which is a male connector, and the mating terminal 200 is housed in the connector housing 401 of a mating connector 400 which is a female connector. The connector 300 and the mating connector 400 are mated with each other to configure a connector unit 1. The connector unit 1 is, for example, a connector for automobile use, which is included in an automobile and used as one of automobile components.

The connector housing 301 is, for example, a member having a generally box shape, in which a mating hole 303 opened in the +X direction is opened, and includes an insulating material, for example, a resin. The connector housing 301 is fixed on a surface of a substrate 500. The mating connector 400 is inserted into the mating hole 303 of the connector housing 301. A plurality of terminal press-fit holes 302 is formed in the connector housing 301. The terminal press-fit holes 302 are holes into which the terminal 100 is press-fitted, and inner surfaces that form the terminal press-fit holes 302 support the terminal 100. The terminal press-fit holes 302 are opened to pass through the connector housing 301 in the X-axis direction. The openings of the terminal press-fit holes 302 in the +X side are inlets into which the terminal 100 is inserted, and tapers for facilitating the insertion of the terminal 100 are formed on the edges of the openings. The shape of the connector housing 301 is an example used for explaining the shape of the terminal 100, and is not limited thereto.

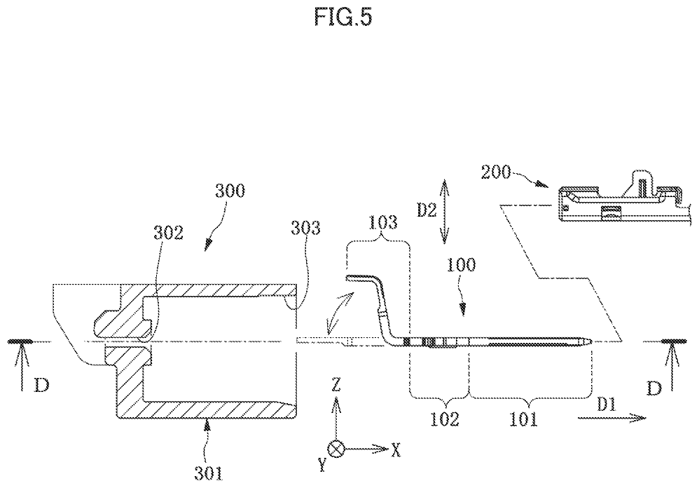

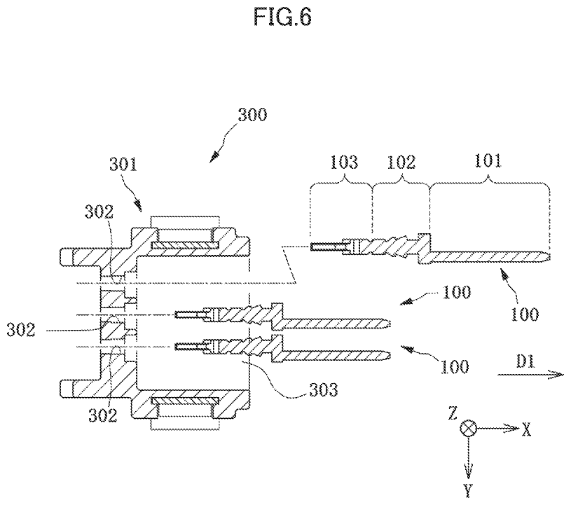

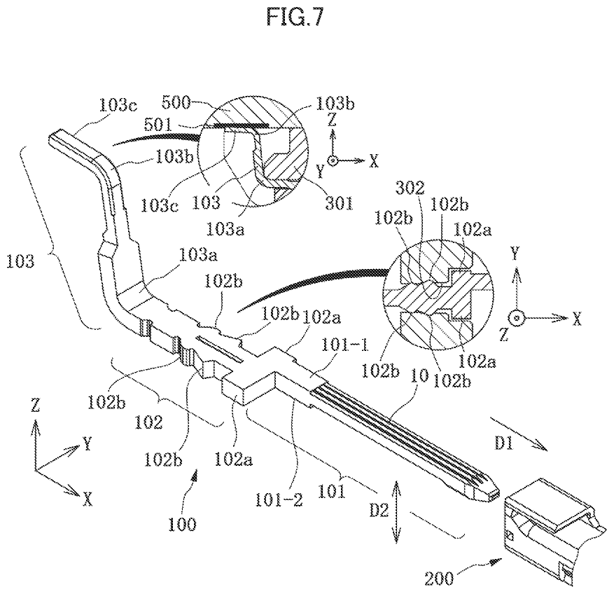

The terminal 100 includes a male terminal. The terminal 100 is inserted between a first contact C1 and a second contact C2 which are formed in the interior of the mating terminal 200. In Embodiment 1, the terminal 100 is a surface mount technology (SMT) terminal of which one end is connected to the conductive portion 501 of the substrate 500. The terminal 100 includes a portion to be press-fitted 102, a mount portion 103 that protrudes from the portion to be press-fitted 102 toward the −X side, and an insertion portion 101 that protrudes from the portion to be press-fitted 102 toward the +X side, as illustrated in FIGS. 5 and 6. In addition to the portion to be press-fitted 102, the mount portion 103, and the insertion portion 101, the terminal 100 further includes first projections 10, a second projection 20, and third projections 30, as illustrated in FIGS. 7 and 8.

The portion to be press-fitted 102 is a portion arranged in the terminal press-fit holes 302 of the connector housing 301 of the connector 300. A tie bar cut portion 102a and lockers 102b and 102c are formed in the portion to be press-fitted 102.

The tie bar cut portion 102a is a portion formed by cutting a tie bar which is the linking portion of a terminal block in which a plurality of terminals 100 is linked. The tie bar cut portion 102a is formed to protrude in both the +Y- and −Y-directions.

The lockers 102b and 102c are disposed at positions closer to the −X side than the tie bar cut portion 102a. The locker 102b is engaged with the inner surface that form each of the terminal press-fit holes 302 to be thereby locked with the inner surface. The locker 102b is formed on an end face of the terminal 100, and configured to include a plurality of projections. The locker 102c is formed on the −Z-surface of the terminal 100. The locker 102c is formed by, for example, allowing a part of the −Z-surface to protrude by punching the reverse +Z-surface.

A first bent portion 103a and a second bent portion 103b are formed on the mount portion 103. The vicinity of the leading end 103c in the −X-side of the mount portion 103 is a portion mounted on the conductive portion 501 of the substrate 500. The mount portion 103 is formed in a shape in which the mount portion 103 protrudes from the portion to be press-fitted 102, is bent in a direction toward the substrate 500 from the first bent portion 103a as a base point, is bent again from the second bent portion 103b as a base point, and is allowed to be along a surface of substrate 500.

As illustrated in FIGS. 3 and 4, the insertion portion 101 is formed to protrude from each terminal press-fit hole 302 into the interior of the mating hole 303 in a state in which the terminal 100 is housed in the connector housing 301. The insertion portion 101 is a portion that comes into contact with the mating terminal 200.

As described above, the terminal 100 including the insertion portion 101 and the like is formed, for example, by stamping a conductive sheet material such as copper or copper alloy, and by performing bending working of the stamped material. As a result, the terminal 100 is formed to have a shape including a first surface 101-1 which is a +Z-surface, a second surface 101-2 which is a −Z-surface, and an end surface which is a cut surface formed in the case of the stamping, as illustrated in FIGS. 7 and 8. In Embodiment 1, the conductive sheet material that forms the terminal 100 is plated. Therefore, the first surface 101-1 and the second surface 101-2 include plated surfaces. The end surface which is the cut surface formed in the case of the stamping includes a cut surface that is not plated.

The first projections 10 are disposed on the first surface 101-1 which is the +Z-surface of the insertion portion 101. The first projections 10 protrude in the orthogonal direction D2 which is a direction orthogonal to the insertion direction D1, specifically, in the +Z-direction while linearly extending in the insertion direction D1. The plurality of first projections 10 is disposed. Specifically, the number of the disposed first projections 10 is four in Embodiment 1. However, the number is not limited thereto. The number of the disposed first projections 10 may be two, three, or five or more. The first projections 10 are formed so as to each have the same height.

The second projection 20 is disposed on the second surface 101-2 which is the −Z-surface of the insertion portion 101. The second projection 20 protrudes in the orthogonal direction D2 which is a direction orthogonal to the insertion direction D1, specifically, in the −Z-direction while linearly extending in the insertion direction D1. Unlike the plurality of disposed first projections 10, the second projection 20, of which the number is one, is formed on the second surface 101-2. The second projection 20 is disposed at a position at which the second projection 20 comes into contact with the second contact C2 in a state in which the terminal 100 and the mating terminal 200 have been connected to each other, as illustrated in FIGS. 2B and 3. In such a case, the first projections 10 also comes into contact with the first contact C1. In other words, the second projection 20 and the first projections 10 are disposed at the position at which the second projection 20 and the first projections 10 come into contact with the mating terminal 200 in a state in which the terminal 100 and the mating terminal 200 have been connected.

The third projections 30 are disposed, on the second surface 101-2, at positions closer to the leading end (+X-side) of the terminal 100 in the insertion direction D1 than the position at which the second projection 20 is disposed, as illustrated in FIG. 8. The third projections 30 protrudes in the orthogonal direction D2 which is a direction orthogonal to the insertion direction D1, specifically, in the −Z-direction while linearly extending in the insertion direction D1. The plurality of third projections 30 is disposed. Specifically, the third projections 30, of which the number is four, is disposed in Embodiment 1. However, the number is not limited thereto. The number of the disposed third projections 30 may be two, three, or five or more. The third projections 30 are disposed to be adjacent to the second projection 20 in the insertion direction D1 without interposing any gap or the like between the third projections 30 and the second projection 20. The third projections 30 are formed so that the height H3 of the third projections protruding in the Z-axis direction is equivalent to the height H2 of the second projection 20 (H3≈H2). In addition, the plurality of third projections 30 is formed so that each of the third projections 30 has the same height H3.

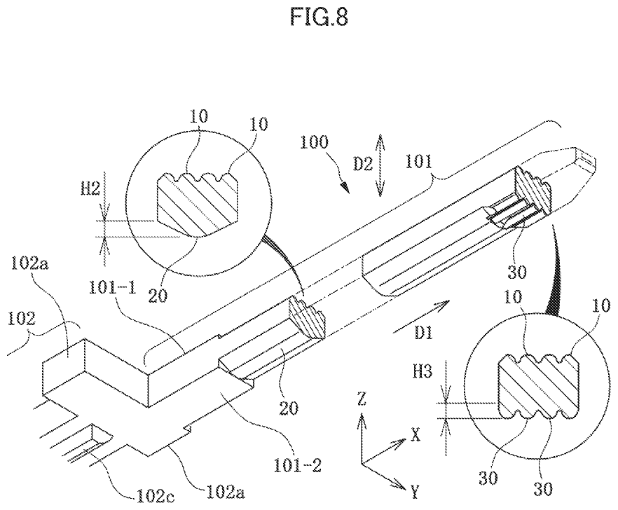

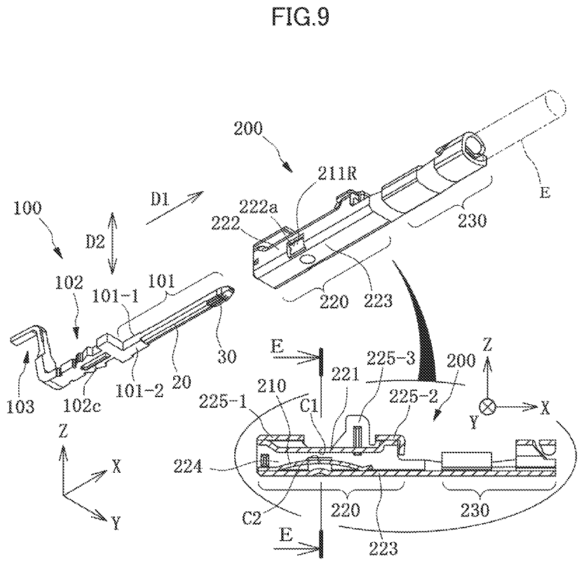

The mating terminal 200 is formed of a female terminal to which the terminal 100 which is a male terminal is connected, as illustrated in FIG. 9. The mating terminal 200 is formed by, for example, performing bending working of a conductive sheet material such as copper or copper alloy. An end of an electric wire E is fixed to the female terminal. The mating terminal 200 includes an elastic plate 210, a body 220, and a crimp 230.

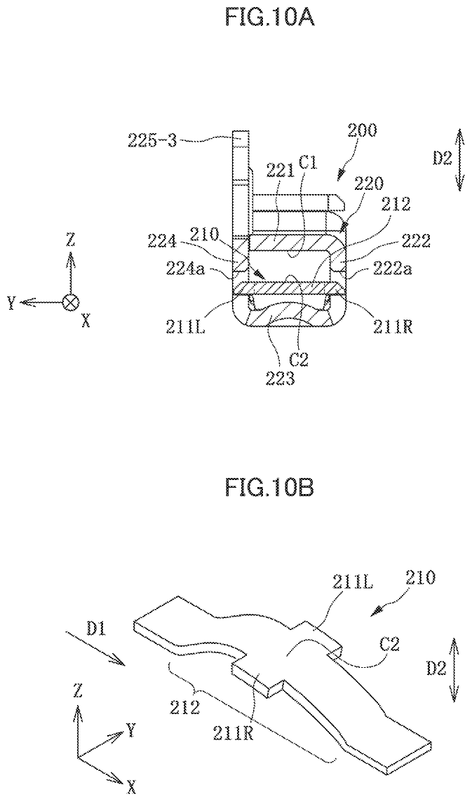

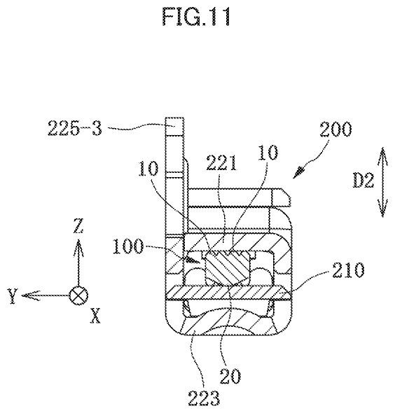

The elastic plate 210 is a plate-shaped member with which the terminal 100 comes into contact. The elastic plate 210 is housed in the interior of the body 220. In Embodiment 1, the elastic plate 210 is formed separately from the body 220 by being formed of a conductive plate-shaped member separate from the body 220. However, the elastic plate 210 is not limited thereto. The elastic plate 210 may be formed integrally with the body 220 by being formed of one conductive plate-shaped member. The elastic plate 210 includes a pair of first and second lockers 211R and 211L protruding from −Y- and +Y-end surfaces, as illustrated in FIGS. 9, 10A, and 10B. In addition to the first locker 211R and the second locker 211L, the elastic plate 210 includes an arch-shaped portion 212 formed to be convex toward the +Z-direction. The elastic plate 210 is formed to be flexible in the Z-axis direction due to the arch-shaped portion 212. The vertex of the arch-shaped portion 212 is formed as the second contact C2. In the elastic plate 210 in Embodiment 1, an indent that is convex toward the +Z-direction is not formed on the +Z-surface of the elastic plate 210, and the +Z-surface is formed as a smooth surface without convexity. As illustrated in FIG. 11, the second projection 20 of the terminal 100 comes into contact with the +Z-surface of the elastic plate 210.

The body 220 is a cylindrical member that can receive the terminal 100 which is a target for connection to the mating terminal 200, as illustrated in FIGS. 9, 10A, and 10B. The body 220 is formed by bending one conductive plate-shaped member together with the crimp 230. The body 220 is formed in a generally square cylindrical shape including a first wall 221 as a +Z-top wall, a second wall 222 as a −Y-side wall, a third wall 223 as a −Z-bottom wall, and a fourth wall 224 as a +Y-side wall.

The first wall 221 is a plate-shaped top wall that is approximately parallel to the XY plane. The first contact C1 that comes into contact with the terminal 100 is disposed on the −Z-lower surface of the first wall 221. As illustrated in FIG. 11, the plurality of first projections 10 comes into contact with the −Z-lower surface of the first wall 221. The −Z-lower surface of the first wall 221 is formed to be an approximately flat surface.

The second wall 222 is a plate-shaped side wall that extends from the first wall 221, is orthogonally bent, and is approximately parallel to the XZ plane, as illustrated in FIGS. 9, 10A, and 10B. A notch 222a with which the first locker 211R formed on the elastic plate 210 is locked is formed in the second wall 222.

The third wall 223 is a plate-shaped bottom wall that extends from the second wall 222, is orthogonally bent, and is approximately parallel to the XY plane. The elastic plate 210 is arranged on the +Z-top surface which is the inner surface of the third wall 223.

The fourth wall 224 is a plate-shaped side wall that extends from the third wall 223, is orthogonally bent, and is approximately parallel to the XZ plane. As a result, the fourth wall 224 faces the second wall 222 which is a side wall. A notch 224a with which the second locker 211L of the elastic plate 210 is locked is formed in the fourth wall 224.

Moreover, extensions 225-1 and 225-2, and a detent projection 225-3 are formed to extend from the fourth wall 224, as illustrated in FIG. 1.

The extensions 225-1 and 225-2 extend from the fourth wall 224, and is orthogonally bent. The extensions 225-1 and 225-2 are arranged on the +Z-surface of the first wall 221, and put on the first wall 221. The extensions 225-1 and 225-2 are formed to enhance the rigidity of the body 220.

The detent projection 225-3 is formed to protrude from the fourth wall 224 in the +Z-direction. The detent projection 225-3 is a stabilizer formed to prevent an operator from incorrectly setting the orientation of the mating terminal 200 when the mating terminal 200 is inserted into the terminal housing chamber of the connector housing 401. Specifically, the detent projection 225-3 is formed to prevent the operator from inserting the terminal 100 in a state in which the terminal 100 is rotated at 90° about the insertion direction D1 (X-axis direction), or from inserting the mating terminal 200 in a state in which the mating terminal 200 is turned upside down. After the insertion of the mating terminal 200 into the terminal housing chamber, the detent projection 225-3 is also used to prevent the whole mating terminal 200 from rotating about the X-axis direction with respect to the terminal housing chamber in which the mating terminal 200 is housed.

The crimp 230 is a portion connected to the electric wire E. The crimp 230 includes a conductor swager and a coating fixer.

The conductor swager is crimped and electrically connected to the conductive core wire of the electric wire E by swaging.

The coating fixer is crimped to an end of the insulated coating of the electric wire E by swaging, and inhibits that electric wire E from being pulled out of the terminal 100.

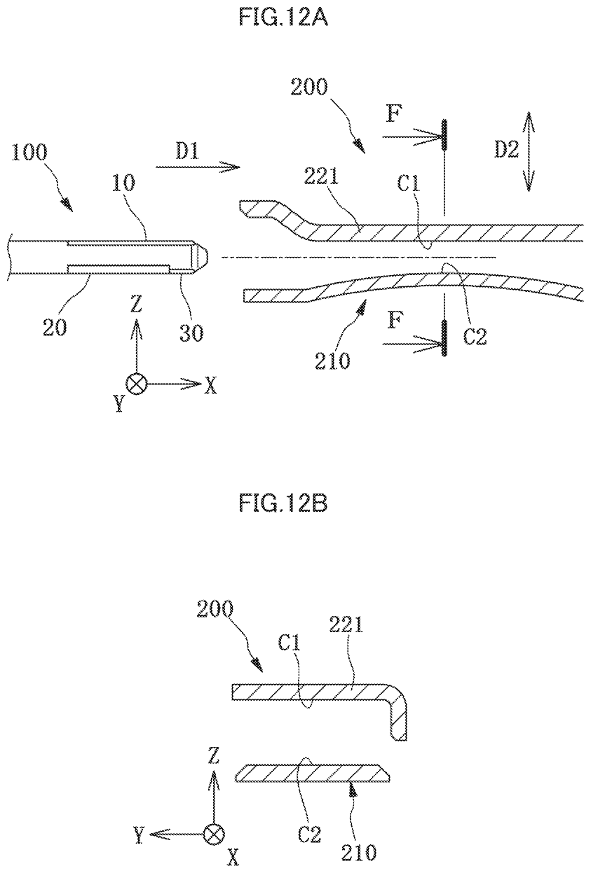

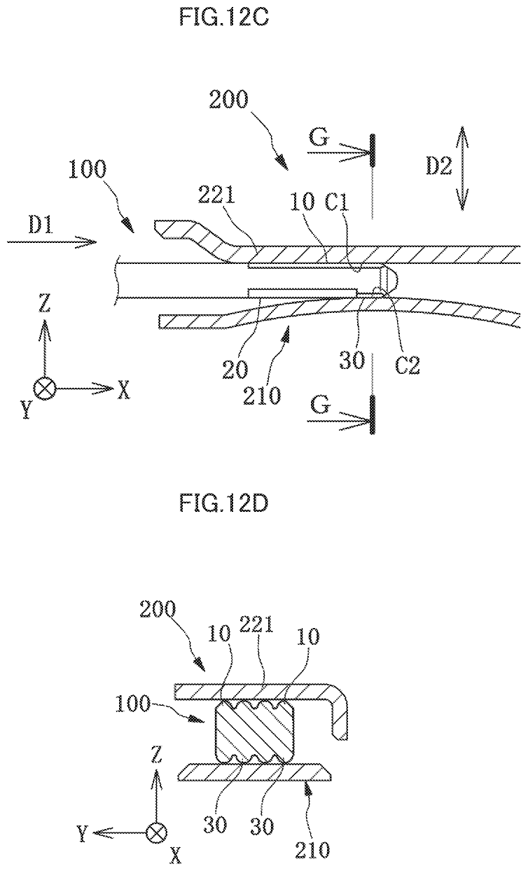

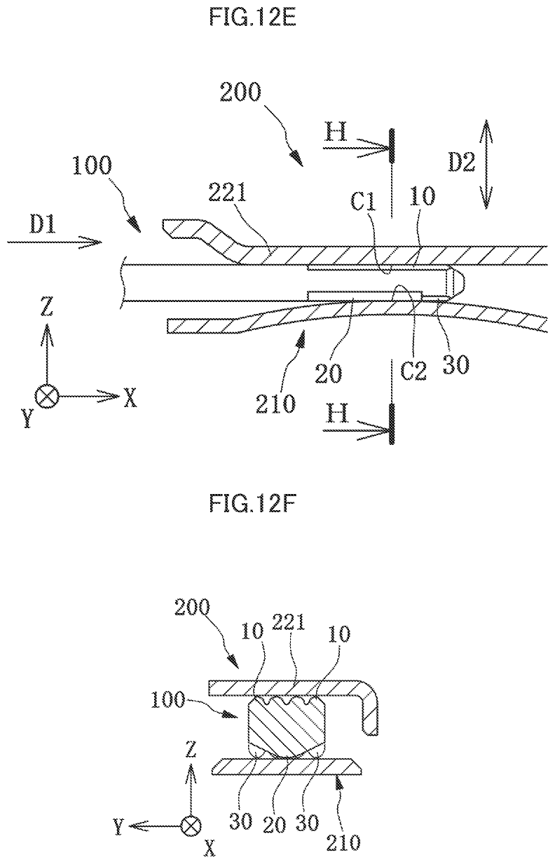

A method of connecting the terminal 100 according to Embodiment 1 to the mating terminal 200 will now be described with reference to FIGS. 12A to 12F.

First, an operator inserts the terminal 100 into between the first wall 221 and elastic plate 210 of the mating terminal 200 along the insertion direction D1, as illustrated in FIGS. 12A and 12C.

The insertion of the terminal 100 into between the first contact C1 and the second contact C2 by the operator allows the first projection 10 of the terminal 100 to arrive at the first contact C1 located on the −Z-lower surface of the first wall 221 in a short time, as illustrated in FIGS. 12B and 12D. The third projections 30 of the terminal 100 also arrives at the second contact C2 located at the apex of the elastic plate 210. The plurality of first projections 10 and the plurality of third projections 30 are disposed while linearly extending in the insertion direction D1. Therefore, the operator can insert the terminal 100 into between the first contact C1 and the second contact C2 without requiring large insertion force.

The further movement of the terminal 100 in the insertion direction D1 allows the second projection 20 of the terminal 100 to arrive at the second contact C2, as illustrated in FIGS. 12E and 12F. In such a case, the third projections 30 leave the second contact C2, and moves to a position that does not come into contact with the second contact C2. The second projection 20 is disposed to adjacent to the third projections 30 in the insertion direction D1, and therefore, there is no gap between the second projection 20 and the third projections 30. In addition, the height H2 of the second projection 20 is equivalent to the height H3 of the third projections 30, and therefore, there is no level difference between the second projection 20 and the third projections 30. As a result, the second contact C2 is prevented from moving over any gap or level difference, and an operator can insert the terminal 100 into between the first contact C1 and the second contact C2 without requiring large insertion force. The plurality of first projections 10 and the second projection 20 are disposed while linearly extending in the insertion direction D1, and therefore, for example, an operator can insert the terminal 100 into between the first contact C1 and the second contact C2 without requiring large insertion force in comparison with Comparative Examples 1 and 2 described later. The first projections 10 come into contact with the first contact C1, and the second projection 20 comes into contact with the second contact C2, whereby both the first projections 10 and the second projection 20 come into contact with the mating terminal 200. As a result, the connection of the terminal 100 and the mating terminal 200 to each other is completed, and the terminal 100 is electrically connected to the mating terminal 200.

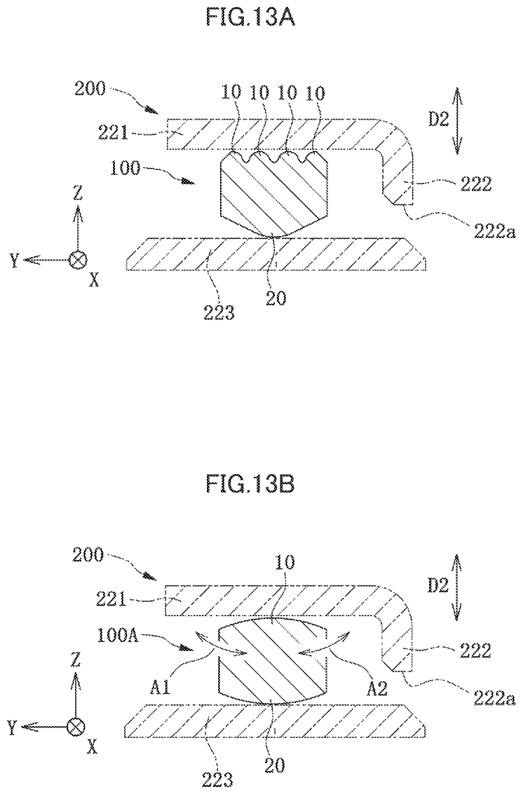

As described above, the terminal 100 according to Embodiment 1 includes the plurality of first projections 10 protruding in the orthogonal direction D2 while linearly extending in the insertion direction D1, as illustrated in FIG. 7. The plurality of first projections 10 is disposed as illustrated in FIG. 13A. The plurality of first projections 10 comes into contact with the −Z-lower surface of the first wall 221. As a result, the terminal 100 is arranged on the −Z-lower surface of the first wall 221 without inclining. As a result, the posture of the terminal 100 on the mating terminal 200 can be stabilized in a state in which the terminal 100 comes into contact with the mating terminal 200.

For example, a terminal 100A according to Comparative Example 1 illustrated in FIG. 13B includes one first projection 10 protruding in an orthogonal direction D2 while linearly extending in the X-axis direction. In such a case, the one first projection 10 comes into line contact with the −Z-lower surface of a first wall 221. As a result, the terminal 100A may incline toward the −Z-lower surface of the first wall 221 on the basis of the apex portion of the first projection 10 as a base point, as indicated by arrows A1 and A2. As a result, the posture of the terminal 100A on a mating terminal 200 may become unstable in a state in which the terminal 100A comes into contact with the mating terminal 200.

In contrast, the terminal 100 according to Embodiment 1 illustrated in FIG. 13A includes the plurality of first projections 10, and therefore, the plurality of first projections 10 comes into multipoint contact with the −Z-lower surface of the first wall 221. Therefore, the terminal 100 is arranged on the −Z-lower surface of the first wall 221 without inclining. As a result, the posture of the terminal 100 on the mating terminal 200 can be stabilized in a state in which the terminal 100 comes into contact with the mating terminal 200. In addition, the posture of the terminal 100 on the mating terminal 200 is stable, and therefore, the terminal 100 taking the stable posture can be inserted into the mating terminal 200. The plurality of first projections 10 is disposed while linearly extending in the insertion direction D1, contact pressure between the terminal 100 and the −Z-lower surface of the first wall 221 can be therefore dispersed in a plurality of places, and therefore, insertion force required for inserting of the terminal 100 into the mating terminal 200 can be reduced. Thus, the efficiency and property of the insertion of the terminal 100 into the mating terminal 200 can be improved in Embodiment 1.

The terminal 100 includes the plurality of first projections 10. Therefore, the plating shavings that can be generated due to the insertion of the terminal 100 into the mating terminal 200 burrow into valleys between the first projections 10. As a result, the inhibition of the insertion of the terminal 100 into the mating terminal 200, caused by the generation of the plating shavings, and an increase in insertion force required for the insertion can be prevented.

The terminal 100 according to Embodiment 1 includes the second projection 20 that protrudes in the orthogonal direction D2 while linearly extending in the insertion direction D1, as illustrated in FIG. 8. The number of the formed second projection 20 is not plural but one. Therefore, the apex portion of the second projection 20 becomes a contact with the mating terminal 200, whereby the second projection 20 can function as an indent that improves the reliability of electrical connection between the terminal 100 and the mating terminal 200. As a result, an indent formed by pressing the terminal 100 from the −Z-surface of the terminal 100 can be eliminated from the elastic plate 210, as illustrated in FIG. 10B.

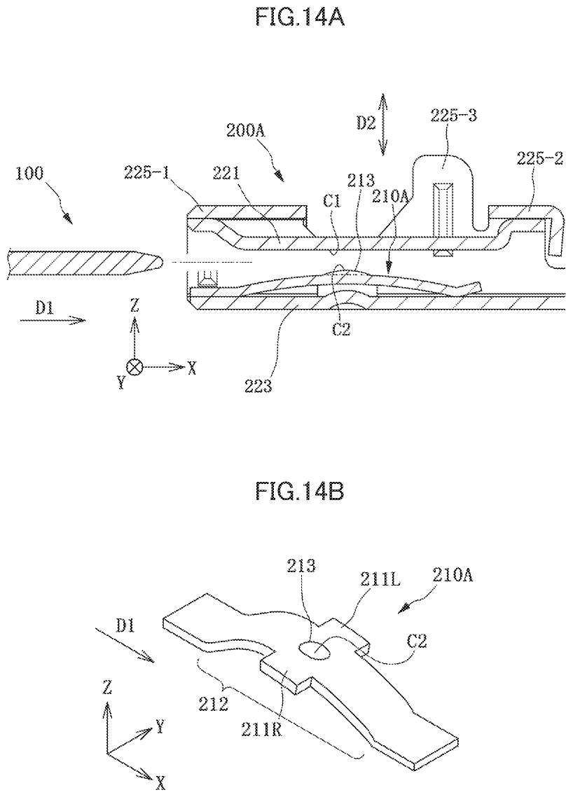

For example, an indent 213 is disposed in the vicinity of the apex portion of an arch-shaped portion 212 in a common elastic plate 210A according to Comparative Example 2 illustrated in FIGS. 14A and 14B. The indent 213 is formed by pressing the elastic plate 210A from the back surface of the elastic plate 210A in the +Z-direction. In Comparative Example 2, the reliability of electrical connection between a terminal 100 and a mating terminal 200A is improved by forming the indent 213 on the elastic plate 210A. However, since the indent 213 protrudes from a surface of the elastic plate 210A, the indent 213 inhibits the insertion of the terminal 100 in the case of inserting the terminal 100 into the mating terminal 200A. As a result, Comparative Example 2 has a problem that high insertion force is required in the case of inserting the terminal 100 into the mating terminal 200A.

In contrast, the terminal 100 according to Embodiment 1 includes the second projection 20 functioning as an indent, instead of the formation of the indent on the mating terminal 200, as illustrated in FIG. 8. Therefore, the indent can be eliminated from the elastic plate 210, as illustrated in FIG. 10B. The elimination of the indent enables insertion force required for inserting the terminal 100 into the mating terminal 200 to be reduced in Embodiment 1. Since the second projection 20 of the terminal 100 functions as an indent, insertion force required for inserting the terminal 100 into the mating terminal 200 can be reduced while maintaining the reliability of electrical connection between the terminal 100 and the mating terminal 200 even if the indent 213 as in the case of Comparative Example 2 is not formed, in Embodiment 1.

The terminal 100 according to Embodiment 1 includes the third projections 30 that protrude in the orthogonal direction D2 while linearly extending in the insertion direction D1, as illustrated in FIG. 8. The third projections 30 is disposed at a position closer to the +X-leading end (closer to the −X-side) of the terminal 100 in the insertion direction D1. Therefore, insertion force required for inserting the terminal 100 into the mating terminal 200 in a stage before the second projection 20 arrives at the second contact C2 can be reduced in Embodiment 1, as illustrated in FIGS. 12C and 12D.

The third projections 30 according to Embodiment 1 is disposed to be adjacent to the second projection 20 in the insertion direction D1. Therefore, there is no gap between the second projection 20 and the third projections 30. As a result, the second contact C2 is prevented from passing through the gap while moving over the gap in the case of inserting the terminal 100 into the mating terminal 200. As a result, insertion force required for inserting the terminal 100 into the mating terminal 200 can be reduced.

The height H3 of the third projections 30 according to Embodiment 1 is equivalent to the height H2 of the second projection 20. Therefore, there is no level difference between the second projection 20 and the third projections 30. As a result, the second contact C2 is prevented from moving over the level difference in the case of inserting the terminal 100 into the mating terminal 200. As a result, insertion force required for inserting the terminal 100 into the mating terminal 200 can be reduced.

### Embodiment 2

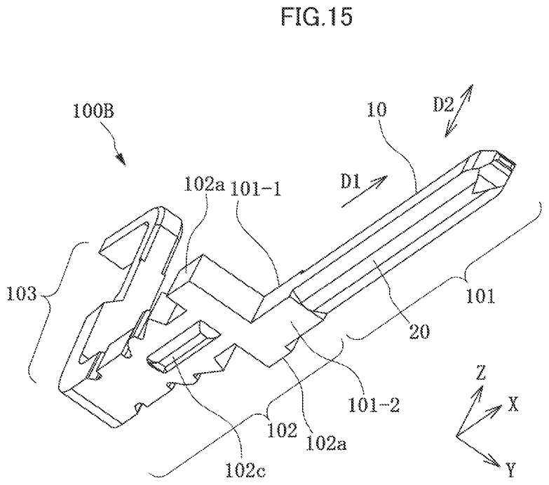

The terminal 100 according to Embodiment 1 includes the third projections 30 disposed on the second surface 101-2, as illustrated in FIG. 8. However, the terminal is not limited thereto. Like a terminal 100B according to Embodiment 2 illustrated in FIG. 15 below, any third projection 30 need not be disposed. In such a case, in the terminal 100B according to Embodiment 2, a second projection 20 may extend up to the vicinity of the leading end of the terminal 100B, as illustrated in FIG. 15.

Since the terminal 100B according to Embodiment 2 does not include any third projection 30, the working of forming the third projections 30 can be eliminated in the process of manufacturing the terminal 100B, so that the complication of the mold working of the terminal 100B can be suppressed. As a result, the manufacturing cost of the terminal 100B can be suppressed. Thus, the manufacturing cost of the terminal 100B can be reduced while the terminal 100B has an effect equivalent to that of the terminal 100 according to Embodiment 1.

The terminal 100B according to Embodiment 2 does not include any third projection 30, and therefore, no gap between the second projection 20 and the third projections 30 is formed. As a result, insertion force required for inserting the terminal 100B into a mating terminal 200 can be further reduced.

Embodiments 1 and 2 of the present disclosure have been described above. However, the present disclosure is not limited to Embodiments 1 and 2 described above.

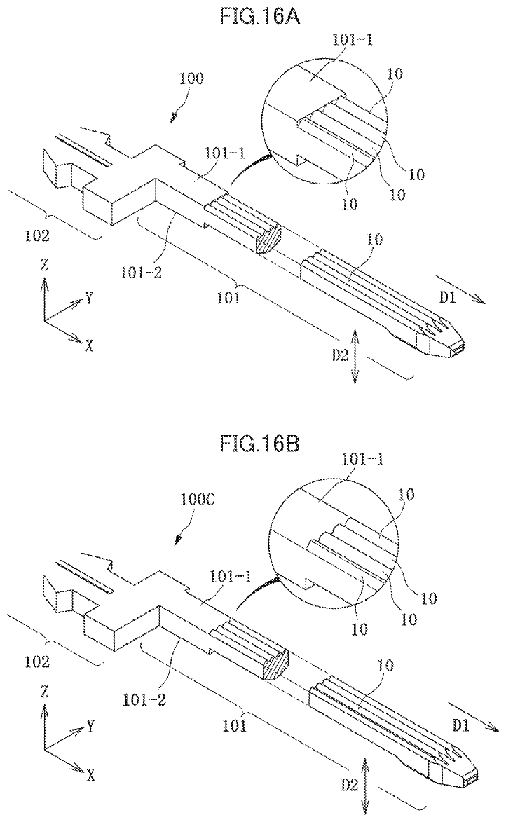

For example, in the terminal 100 according to Embodiment 1, the first projections 10 are formed by cutting parts of the first surface 101-1, or by forming a plurality of grooves on the first surface 101-1, as illustrated in FIG. 16A. As a result, the vertexes of the first projections 10 are formed to have a height equivalent to that of the first surface 101-1 in the Z-axis direction. Likewise, in the terminal 100B according to Embodiment 2 illustrated in FIG. 15, the vertex of a first projection 10 is also formed to have a height equivalent to that of a first surface 101-1 in the Z-axis direction, as illustrated in FIGS. 16A and 16B. However, the terminal is not limited thereto. Like a terminal 100C according to Alternative Example 1 illustrated in FIG. 16B, a first projection 10 may be formed to protrude from a first surface 101-1.

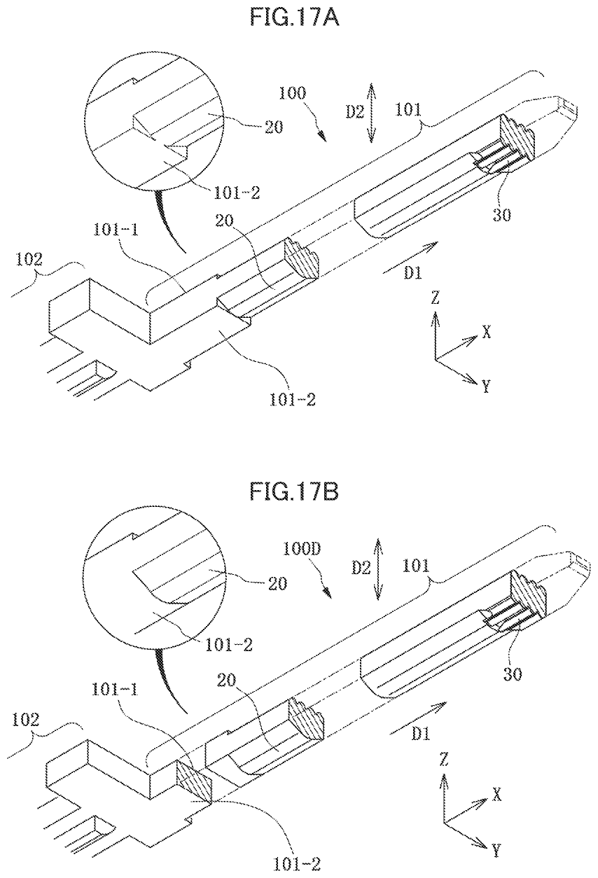

In the terminal 100 according to Embodiment 1, the second projection 20 and the third projections 30 are formed by cutting parts of the second surface 101-2, or by forming a plurality of grooves on the second surface 101-2, as illustrated in FIG. 17A. As a result, the vertexes of the second projection 20 and the third projections 30 are formed to have heights equivalent to that of the second surface 101-2 in the Z-axis direction. Likewise, in the terminal 100B according to Embodiment 2, the vertex of the second projection 20 is also formed to have a height equivalent to that of the second surface 101-2 in the Z-axis direction, as illustrated in FIG. 15. However, the terminal is not limited thereto. Like a terminal 100D according to Alternative Example 2 illustrated in FIG. 17B, a second projection 20 and third projections 30 may be formed to protrude from a second surface 101-2.

In the terminal 100 according to Embodiment 1, the height H3 of the third projections 30 is equivalent to the height H2 of the second projection 20, as illustrated in FIG. 8. However, the terminal is not limited thereto. The height H3 of the third projections 30 may be formed so that the height H3 is higher than the height H2 of the second projection 20 (H3>H2). In such a case, the second contact C2 is transferred to move down from the third projections 30 to the second projection 20 when the terminal 100 is inserted into the mating terminal 200. Therefore, like Embodiment 1 in which the height H3 of the third projections 30 and the height H2 of the second projection 20 are equivalent to each other, insertion force required for inserting the terminal 100 into the mating terminal 200 can be inhibited from increasing.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.
1: Connector unit
10: First projection
20: Second projection
30: Third projection
100, 100A, 100B, 100C, 100D: Terminal
101: Insertion portion
101-1: First surface
101-2: Second surface
102: Portion to be press-fitted
102a: Tie bar cut portion
102b, 102c: Locker
103: Mount portion
103a: First bent portion
103b: Second bent portion
103c: Leading end
200, 200A: Mating terminal
210, 210A: Elastic plate
211R: First locker
211L: Second locker
212: Arch-shaped portion
213: Indent
220: Body
221: First wall
222: Second wall
222a, 224a: Notch
223: Third wall
224: Fourth wall
225-1, 225-2: Extension
225-3: Detent projection
230: Crimp
300: Connector
301, 401: Connector housing
302: Terminal press-fit hole
303: Mating hole
400: Mating connector
500: Substrate
501: Conductive portion
C1: First contact
C2: Second contact
D1: Insertion direction
D2: Orthogonal direction
E: Electric wire
H2, H3: Height
A1, A2: Arrow

What is claimed is:

1. A terminal inserted between a first contact and a second contact, formed in an interior of a mating terminal,
the terminal being formed in a shape comprising a first surface that comes into contact with the first contact and a second surface that comes into contact with the second contact,
the terminal comprising:
a plurality of first projections that is disposed on the first surface, and protrude in an orthogonal direction orthogonal to an insertion direction while linearly extending in the insertion direction in which the terminal is inserted into the mating terminal; and
a second projection that is disposed on the second surface, and protrudes in the orthogonal direction,
wherein the first projections are disposed at positions at which the first projections come into contact with the first contact, and the second projection is disposed at a position at which the second projection comes into contact with the second contact, in a state in which the terminal has been connected to the mating terminal.

2. The terminal according to claim 1, wherein the second projection of which a number is one is formed on the second surface, and linearly extends in the insertion direction.

3. The terminal according to claim 1, comprising a plurality of third projections that is disposed on the second surface, is disposed at positions closer to a leading end of the terminal in the insertion direction than the position at which the second projection is disposed, and protrudes in the orthogonal direction while linearly extending in the insertion direction.

4. The terminal according to claim 3, wherein the third projections are disposed to be adjacent to the second projection in the insertion direction.

5. The terminal according to claim 3, wherein the third projections are formed so that heights of the third projections that protrude in the orthogonal direction are equivalent to a height of the second projection.

6. The terminal according to claim 3, wherein the third projections are formed so that the heights of the third projections that protrude in the orthogonal direction are higher than the height of the second projection.
